(19) United States
(12) Patent Application Publication
(10) Pub. No.: US 2009/0307578 A1
(43) Pub. Date: Dec. 10, 2009

(54) TOP DOWN CHINESE CHARACTER DISPLAY ON A COMPUTING DEVICE

(75) Inventor: Xin Wei, Shenzhen (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/133,382

(22) Filed: Jun. 5, 2008

(51) Int. Cl. G06F 17/00

(52) U.S. Cl. 715/227

(57) ABSTRACT

A control for formatting vertically orientated languages, such as Chinese, Korean and Japanese, for display in a browser. Vertically oriented text may be placed into a table, such that a column of text represents a sentence, and each row defines a cell containing a word in the sentence. Succeeding sentences may be added into additional columns in the table. The table may be defined using a markup language and placed into a document. The document may contain formatting that scales the table or may be dynamically generated such that the vertically oriented text is displayed in a browser or other application.

### BACKGROUND

Many Asian languages, such as Chinese, Japanese and Korean languages may be written horizontally or vertically. Traditional Chinese, Japanese, and Korean written text is oriented vertically in columns that are read from top to bottom and ordered from right to left. Each new column is starting to the left of the preceding one to accommodate the stroke order direction of Chinese characters. It has become increasingly common for these languages to be written horizontally from left to right, with successive rows going from top to bottom, similar to the English language. However, the traditional vertical orientation is still used for many purposes, such as in poems, banners, and other literary works.

Applications, such as browsers, on mobile computing devices support the horizontal presentation of Asian character-based languages in textual format; however, they do not provide support for the vertical presentation in textual format. To view the traditional vertical Asian language, the applications often display images of the characters, which makes it difficult to read and scale on some user interface displays.

### SUMMARY

A control for formatting vertically orientated languages, such as Chinese, Korean and Japanese, for display in a browser or other applications. Vertically oriented text may be placed into a table, such that a column of text represents a sentence, and each row defines a cell containing a word in the sentence. Succeeding sentences may be added in columns to the table. The table may be defined using a markup language and placed into a document. The document may contain formatting that scales the table, and thus, the vertically oriented text at a resolution appropriate for the browser.

In some implementations, a method of representing word-based text having a vertical orientation may be provided. The method may include defining a table using a markup language definition; representing each sentence in the character-based text in a column of the table; representing each word in the sentence in a cell associated with a row and the column; and creating a document containing the markup language definition of the table, the markup language definition formatting each sentence in the vertical orientation to be read in a predetermined direction.

In some implementations, a system for generating character-based text having a vertical orientation may include a server that receives a request for the character-based text, and a formatting engine that defines a table using a markup language definition. The formatting engine may represent each sentence in the character-based text in a column of the table, and represent each word in the sentence in a cell associated with a row and the column such that each sentence is defined in the vertical orientation. The formatting engine may prepare a markup language definition document containing the table to be served in response to the request.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

FIG. 1 is exemplary Chinese character-based text section;

FIG. 2 illustrates the character-based text section of FIG. 1 in a table;

FIG. 3 illustrates an exemplary process for representing character-based text having a vertical orientation;

FIG. 4 illustrates an exemplary process for processing a request for character-based text having a vertical orientation; and

FIG. 5 shows an exemplary environment.

### DETAILED DESCRIPTION

Methods and systems are provided to enable the presentation of vertically oriented written language symbols and/or words in a textual format. According to some implementations, a control may be provided for WAP pages using markup languages, such as HyperText Markup Language (HTML), Extensible HyperText Markup Language (XHTML) and Compact HyperText Markup Language (CHTML) to display vertically oriented (top down) written languages in an application, such as a browser running on a computing device. A designer may use the control to format the words in each sentence of a text section, such that the words are written from top to down in one column, and sentences are written in different columns.

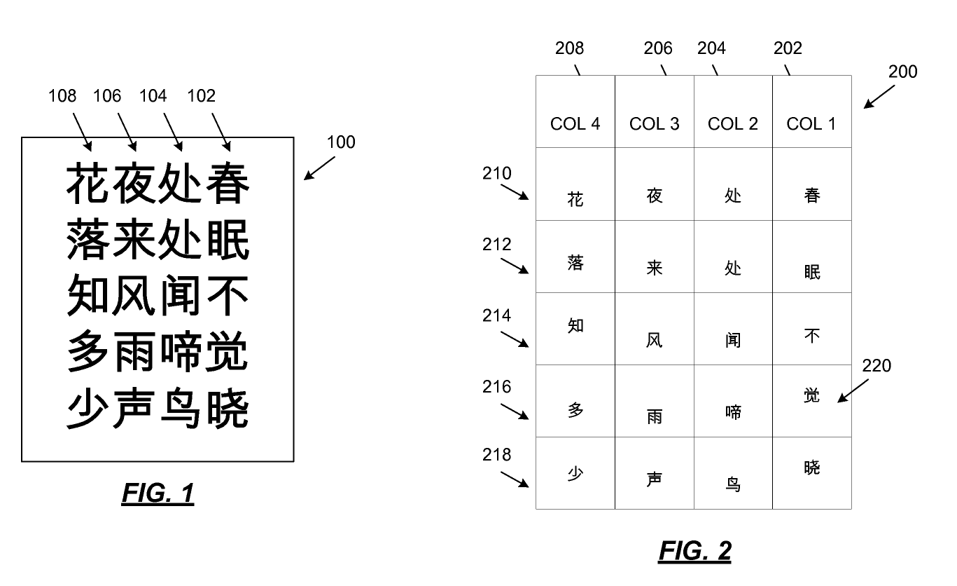

FIG. 1 is exemplary Chinese character-based text section 100. The character-based text section 100 may be a poem, banner, or other passage written in a traditional vertical orientation. The character-based text section 100 includes four sentences, one sentence in each of columns 102, 104, 106 and 108 that are read from right to left. The words in each sentence, represented by Chinese symbols/words, are read from top to bottom in each column 102, 104, 106 and 108.

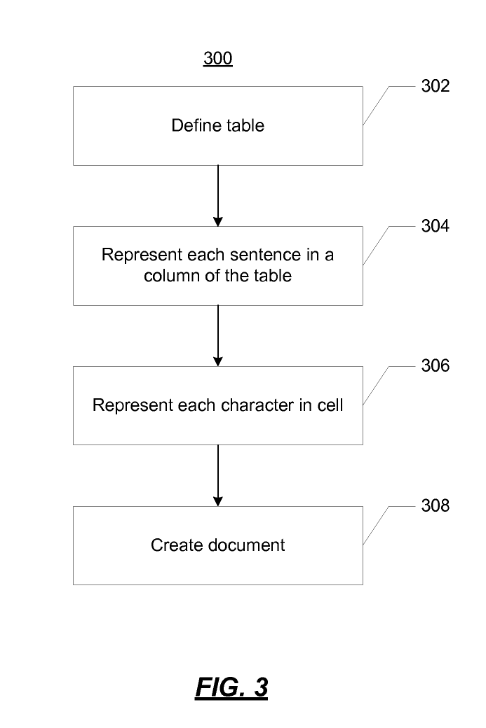

FIG. 2 illustrates the character-based text section 100 of FIG. 1 in a table 200. The table 200 may be used to format the sentences in the character-based text section 100 display in an application such as a browser running on a computing device. In the table 200, columns 202, 204, 206 and 208 represent the sentences in the character-based text section 100, and rows 210, 212, 214, 216 and 218 represent words in each of the respective sentences. Within each cell (e.g., 220), a symbol and/or word from the character-based text section 100 may be placed.

According to some implementations, HTML, XHTML and CHTML table tags may be used to define the table 200. As such, the table 200 may be defined, as follows:

```
<table cellspaceing=0 cellPadding=0 border=0>
        <tr>
            <td> [symbol] </td>
            <td> [symbol] </td>
            <td> [symbol] </td>
            <td> [symbol] </td>
        </tr>
        <tr>
            <td> [symbol] </td>
            <td> [symbol] </td>
            <td> [symbol] </td>
            <td> [symbol] </td>
        </tr>
        <tr>
            <td> [symbol] </td>
            <td> [symbol] </td>
            <td> [symbol] </td>
            <td> [symbol] </td>
        </tr>
        <tr>
            <td> [symbol] </td>
            <td> [symbol] </td>
            <td> [symbol] </td>
            <td> [symbol] </td>
        </tr>
        <tr>
            <td> [symbol] </td>
            <td> [symbol] </td>
            <td> [symbol] </td>
            <td> [symbol] </td>
        </tr>
</table>
```

The <table> tag above defines an instance of the table within the document, the <tr> tag defines the rows, and the <td> tag defines the cell contents. The <table> tag may also include definitions of table headers and other tables. In some implementations, the borders and cell lines of the table 200 may be hidden, set to a zero pixel width, or defined to be the same color as a background of a web page to provide an appearance such as shown in FIG. 1 when displayed in a browser. In addition, cell spacing may be altered by the table tag to adjust the distance between the vertically oriented sentences. Because tables and their contents may be defined using the table tags in markup languages such as HTML, XHTML and CHTML, the character-based text section 100 may be presented in a browser as text-base symbols rather than as an image by communicating the table definition as part of a HTML, XHTML and CHTML document to the browser. Other markup languages having similar constructs may be used to define the table 200.

Defining the character-based text section 100 as the table 200 using table tags provides a mechanism by which the table 200 (and the character-based text defined therein) may be formatted for display in a browser. According to an implementation, the browser may determine how to display the table 200 when a document containing a definition of the table 200 is communicated from a web server. In WML, the basic display unit of content is a “card,” which is the WAP equivalent of HTML pages, and may be text, images, hyperlinks, and input fields. A mobile computing device may retrieve a deck of one or more cards, rather than continually request and retrieve individual cards. The mobile computing device may employ logic, such as embedded WMLScript (the WAP equivalent of client-side JavaScript) for processing these cards and the resultant user inputs. Thus, the mobile computing device may render the character-based text in accordance with specifics of the device's display area.

In an implementation, Cascading Style Sheets (CSS) may be used to define the presentation of the table 200 in the browser. CSS may be used to define colors, fonts, layout, and other aspects of document presentation. Using CSS, the same document may be presented in different styles for different browsers, such that the character-based text in the table 200 may be scaled to the browser display area using either relative or absolute units. Relative length units specify a length relative to another length property. Style sheets that use relative units will more easily scale from one medium or device to another. The relative units may be: the font-size of the relevant font (em), the ‘x-height’ of the relevant font (ex), and a pixel value relative to the viewing device (px). Pixel units are relative to the resolution of the viewing device, such as the screen of the mobile computing device. Absolute units define aspects of the formatting using absolute measurements of the browser display area.

In some implementations, the height and width of a device's display are may be communicated to the web server during a request from a device. The web server may then dynamically format the table layout in the document returned to the device. In some implementations, using the HTTP headers provided by browsers, such as a string in “user-agent,” the model of a mobile computing device may be determined. Using information in the string, a database containing device specifications may be queried to determine the native display size on the mobile computing device. The web server may then provide an appropriately sized table based on the user-agent to the device. In some implementations, the “user-agent” information may be the size of the device's display area, from which the table definition in the document may be formatted for the device.

In browsers that only support Wireless Markup Language (WML), the span tag may be used to define the location of the poem, as WML does not support the table tag. The span tag may be used to affect text and images to provide for control and manipulation of a web page.

FIG. 3 illustrates an exemplary process 300 for representing character-based text section having a vertical orientation. At 302, a table is defined. The table may be defined having a number of columns equal to the number of sentences, and a number of rows equal to the number of words in the longest sentence in the text to be formatted. At 304, each sentence in the character-based text is represented in a column of the table. At 306, each word in the sentence is represented in a cell associated with a row and the column. Each sentence may be formatted to be read from top to bottom where a character is defined in each cell, and the sentences in the text is formatted to be read from right to left in the table, as shown in FIG. 2. At 308, a document is created containing the markup language definition of the table. The markup language definition may define formatting of character-based text within the table, such that each sentence in the character-based text may be read in the table having the vertical orientation, as described above.

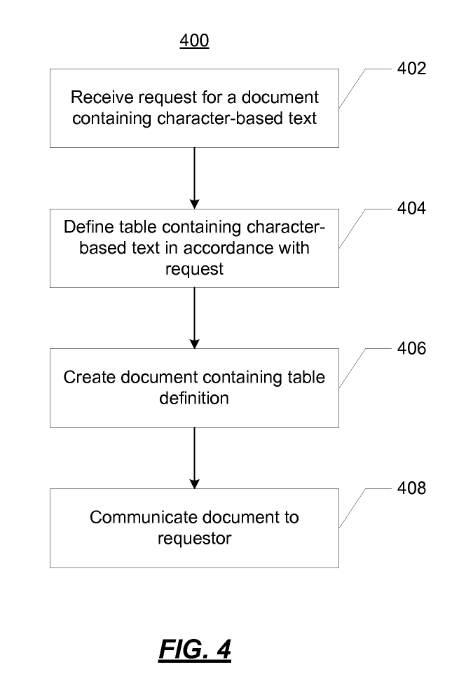

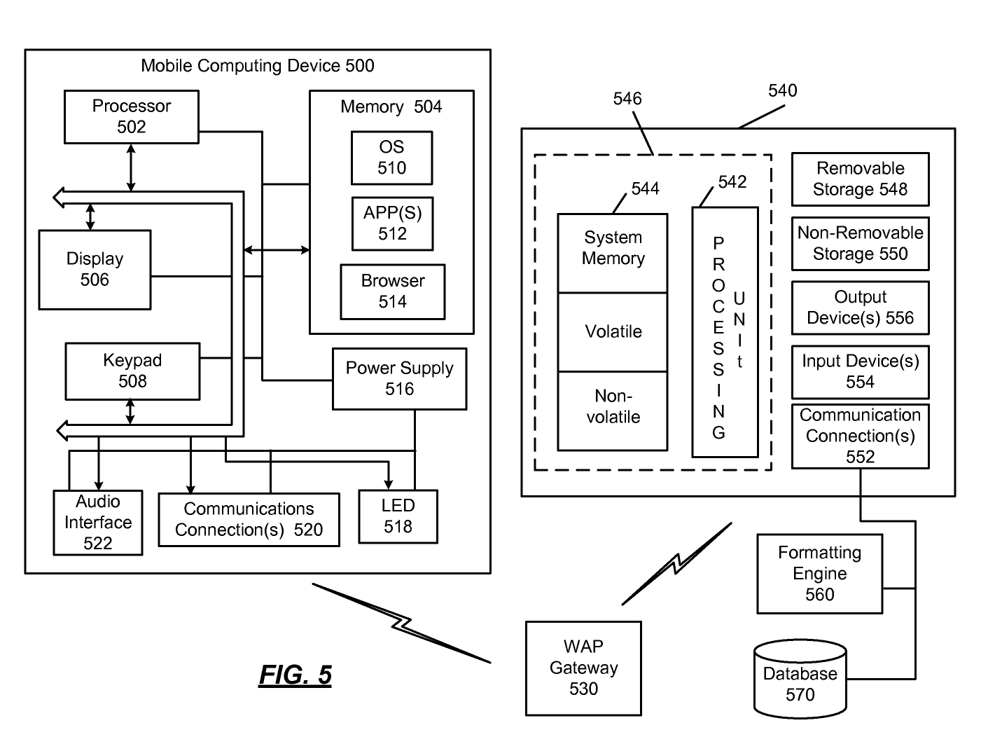

FIG. 4 illustrates an exemplary process 400 for processing a request for character-based text having a vertical orientation. At 402, a request for a document containing character-based text is received. The request may be made by a mobile computing device or other computing device using an application such as a browser. At 404, a table containing the character-based text is defined based on the request. In some implementations, information communicated in the request may be used to define the relative dimensions of the table using a markup language definition. A database of devices may be queried for the device display characteristics based on an identifier in the request, or the request may communicate the device's display characteristics. In some implementations, the device display area may be communicated directly in the request.

At 406, a document is created containing the table definition. The document may be created containing a table where sentences in the character-based text are populated into columns such that each sentence is defined in the vertical orientation, as shown in FIG. 2. At 408, the document is communicated to the requester. This may be accomplished using a referrer IP address of the requester.

Thus, as fully described above, vertically oriented character-based written languages, such as Chinese, Korean and Japanese may be dynamically formatted for display in a browser using table definitions, and the like, in markup language documents communicated to computing devices.

Illustrative Operating Environment

FIG. 5 illustrates an exemplary environment in which aspects of the disclosure may be implemented. A mobile computing device 500 includes processor 502, memory 504, display 506, and keypad 508. Memory 504 generally includes both volatile memory (e.g., RAM) and non-volatile memory (e.g., ROM, Flash Memory, or the like). Mobile computing device 500 includes operating system 510, such as the WINDOWS MOBILE 6 operating system, or another operating system, which is resident in memory 504 and executes on processor 502. Mobile computing device 500 may be configured in many different ways. For example, mobile computing device 500 could be a mobile phone, a PDA, a mobile computer, and the like. Keypad 508 may be a push button numeric dialing pad (such as on a typical telephone), a multi-key keyboard (such as a conventional keyboard). Display 506 may be a liquid crystal display, or any other type of display commonly used in mobile computing devices. Display 506 may be touch-sensitive, and may act as an input device.

One or more application programs 512 are loaded into memory 504 and run on the operating system 510. Browser application 514 is configured to retrieve and display documents from web servers accessible over a network, such as the Internet, LAN, WAN or a local web server running on the mobile computing device 500. The applications may reside in the hardware or software of the mobile computing device 500. Mobile computing device 500 also includes non-volatile storage within memory 504. Non-volatile storage may be used to store persistent information which should not be lost if mobile computing device 500 is powered down.

Mobile computing device 500 includes power supply 516, which may be implemented as one or more batteries. Power supply 516 might further include an external power source, such as an AC adapter or a powered docking cradle that supplements or recharges the batteries.

Mobile computing device 500 is shown with two types of optional external notification mechanisms: LED 518 and audio interface 522. These devices may be directly coupled to power supply 516 so that when activated, they remain on for a duration dictated by a notification mechanism even though processor 502 and other components might shut down to conserve battery power. Audio interface 522 is used to provide audible signals to and receive audible signals from the user. For example, audio interface 522 may be coupled to a speaker for providing audible output and to a microphone for receiving audible input, such as to facilitate a telephone conversation.

Mobile computing device 500 also includes communications connection(s) 520, such as a wireless interface layer, that performs the function of transmitting and receiving communications, or a wired interface, such as a USB connection between the mobile computing device 500 and another computing device. Communications connection(s) 520 facilitates wireless connectivity between the mobile computing device 500 and the outside world. The communication connection may be configured to connect to any type of wireless network. According to one implementation, transmissions to and from communications connection(s) 520 are conducted under control of the operating system 510.

A WAP Gateway 530 may serve as proxy or a service enabler located in the service layer, between the Internet and mobile networks. The service layer may include other service enablers for internet mobile applications, such as charging systems and mobile positioning systems. The WAP protocol runs like a tunnel from the mobile via radio communications towards the connectivity layer, the control layer and finally the service layer. WAP protocols are mobile network independent and work on top of different mobile networks such as GPRS, EDGE and WCDMA. WAP protocols are binary-based protocols and web servers do not support WAP protocols, thus the WAP gateway operates as a protocol converter between WAP protocols and common HTTP/TCP used by web servers on the Internet.

A web server 540 may be a computing device on the Internet running a process to serve web pages or other content. A particular web server may be identified by a Uniform Resource Locator (URL) or Internet Protocol (IP) address. The web server 540 may communicate a web page or other documents to the browser application 514. This information is usually in HTML or XHTML format, and may provide navigation to other web pages via hypertext links. Web pages may be requested and served from web servers using Hypertext Transfer Protocol (HTTP) or WAP.

Web pages may be defined from files of static text stored within the web server's file system (i.e., static web pages), or the web server may construct the XHTML or HTML for each web page when it is requested by a browser (i.e., dynamic web pages). Client-side scripting can make web pages more responsive to user input once in the client browser.

A formatting engine 560 may dynamically or statically create or retrieve the web pages in response to requests for documents received by the web server 540. A database 570 may store information about client devices, such as mobile computing device 500, store web pages to be served by the web server 540, or both. While the formatting engine 560 and database 570 are shown as being separate devices, they each may be included as part of the web server 540, or run on the same device.

For purposes of illustration, the web server 540 may be understood to be an exemplary general-purpose computing device having at least one processing unit 542 and memory 544. Depending on the exact configuration and type of computing device, memory 544 may be volatile (such as random access memory (RAM)), non-volatile (such as read-only memory (ROM), flash memory, etc.), or some combination of the two. A basic configuration is illustrated in FIG. 5 by dashed line 546.

The web server 540 may have additional features/functionality. For example, the web server 540 may include additional storage (removable and/or non-removable) including, but not limited to, magnetic or optical disks or tape. Such additional storage is illustrated in FIG. 5 by removable storage 548 and non-removable storage 550.

The web server 540 typically includes a variety of computer readable media. Computer readable media can be any available media that can be accessed by the web server 540 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 544, removable storage 548, and non-removable storage 550 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the web server 540. Any such computer storage media may be part of the web server 540.

The web server 540 may contain communications connection(s) 552 that allow the device to communicate with other devices. The web server 540 may also have input device(s) 554 such as a keyboard, mouse, pen, voice input device, touch input device, etc. Output device(s) 556 such as a display, speakers, printer, etc. may also be included. All these devices are well known in the art and need not be discussed at length here.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of representing character-based text having a vertical orientation, comprising:
defining a table using a markup language definition;
representing each sentence in the character-based text in a column of the table;
representing each word in the sentence in a cell associated with a row and the column; and
creating a document containing the markup language definition of the table, the markup language definition formatting each sentence in the vertical orientation to be read in a predetermined direction.

2. The method of claim 1, further comprising defining formatting of the document scaled for display in a browser.

3. The method of claim 2, further comprising defining the document using relative length units in cascading style sheets.

4. The method of claim 2, further comprising:
receiving dimension information associated with the browser; and
dynamically formatting the document in accordance with the dimension information.

5. The method of claim 4, further comprising receiving:
a user-agent string from the browser; and
determining the dimension information from the user-agent string.

6. The method of claim 2, further comprising defining the formatting for the browser executing on a mobile computing device.

7. The method of claim 1, further comprising defining the formatting of the document using a table tag defined by the markup language.

8. The method of claim 7, further comprising defining the table with hidden borders and cell lines.

9. The method of claim 1, further comprising populating the table with text-based Asian language characters.

10. A system for generating character-based text having a vertical orientation, comprising:
a server that receives a request for the character-based text; and
a formatting engine that defines a table using a markup language definition, the formatting engine representing each sentence in the character-based text in a column of the table, and representing each word in the sentence in a cell associated with a row and the column such that each sentence is defined in the vertical orientation,
wherein the formatting engine prepares a markup language definition document containing the table to be served in response to the request.

11. The system of claim 10, wherein the document is formatted to be scalable for display in a browser.

12. The system of claim 11, wherein the formatting engine defines the document using relative length units in cascading style sheets.

13. The system of claim 11, further comprising a database containing information used to format the document,
wherein the server receives dimension information associated with the browser, and wherein the formatting engine dynamically formats the document in accordance with the dimension information and information in the database.

14. The system of claim 11, wherein a user-agent string is received from the requester, and wherein the table is formatted in accordance with information in the user-agent string.

15. The system of claim 10, wherein the formatting engine formats the table using a table tag defined by the markup language.

16. A computer-storage medium having computer executable instructions for representing a vertically oriented written language, the method comprising:
representing each sentence in the vertically oriented written language in a column of a table;
representing each word in the sentence in a cell associated with a row and the column;
creating a document containing a markup definition of the table, the document containing formatting information regarding the layout of the table to present each sentence in the vertical orientation; and
serving the document in response to a request.

17. The computer-storage medium of claim 16, wherein the formatting information is determined dynamically in response to the request.

18. The computer-storage medium of claim 17, wherein a user-agent string is received as part of the request, and the formatting information scales the table in accordance with information contained user-agent string.

19. The computer-storage medium of claim 16, wherein the formatting information is defined by relative length units in cascading style sheets.

20. The computer-storage medium of claim 16, wherein the formatting of the document is specified using a table tag defined by the markup language definition.
